(19) United States
(12) Patent Application Publication
(10) Pub. No.: US 2013/0055713 A1
(43) Pub. Date: Mar. 7, 2013

(54) CYLINDER HEAD

(71) Applicants: Hans DRANGEL, Torino (IT); Lorenzo MAGRO, Torino (IT); Luca TRABUCCHI, Grugliasco (IT)

(72) Inventors: Hans DRANGEL, Torino (IT); Lorenzo MAGRO, Torino (IT); Luca TRABUCCHI, Grugliasco (IT)

(73) Assignee: GM GLOBAL TECHNOLOGY OPERATIONS LLC, Detroit, MI (US)

(21) Appl. No.: 13/599,216

(22) Filed: Aug. 30, 2012

(30) Foreign Application Priority Data
Aug. 30, 2011 (GB) 1114970.5

(51) Int. Cl. F02F 1/24; F02B 37/00

(52) U.S. Cl. 60/605.1; 123/193.5

(57) ABSTRACT

A cylinder head is provided for an internal combustion engine, defining a plurality of exhaust ports and an exhaust outlet and an exhaust manifold internally defined by the cylinder head. The exhaust manifold includes, but is not limited to, a collector volume in communication with the exhaust ports, through a plurality of exhaust runners, and with the exhaust outlet. A turbocharger housing is defined by the cylinder head and includes, but is not limited to a turbine volume internally defined by the cylinder head in fluid communication with the exhaust outlet of the exhaust manifold.

### CROSS-REFERENCE TO RELATED APPLICATION

This application claims priority to British Patent Application No. 1114970.5, filed Aug. 30, 2011, which is incorporated herein by reference in its entirety.

### TECHNICAL FIELD

The technical field relates to a cylinder head for an internal combustion engine, typically for an internal combustion engine of a motor vehicle.

### BACKGROUND

An internal combustion engine conventionally comprises an engine block including one or more cylinders, and a cylinder head attached to the cylinder block to close the top of the cylinders. The engine block and the cylinder head are generally formed as aluminum or iron castings.

Each of the cylinders accommodates a piston that cooperates with the cylinder head to define a combustion chamber. A fuel and air mixture is disposed in the combustion chamber and ignited, resulting in hot expanding exhaust gasses causing reciprocating movement of the piston. The fuel may be provided through a fuel injector, which injects the fuel directly into the combustion chamber. The pistons are mechanically coupled to a crankshaft, so that the reciprocating movement of the pistons is converted into a rotation of the engine crankshaft.

Each of the cylinders is equipped with at least an intake valve and an exhaust valve, which are actuated by a camshaft rotating in time with the crankshaft. These valves selectively allow the air into the combustion chamber from at least an intake port, and alternately allow the exhaust gases to exit through at least an exhaust port. The intake ports and the exhaust ports are internally defined by the cylinder head.

The air may be distributed to the intake ports through an intake manifold. The intake manifold is conventionally formed from aluminum or plastic and it is attached to the cylinder head. The intake manifold includes runner portions in communication with each of the intake ports of the cylinder head, and a collector volume in communication with each of the intake runner portions and with an intake pipe that conveys air from the ambient environment.

The exhaust gases from the combustion chamber may be collected in an exhaust manifold. The exhaust manifold includes runner portions in communication with each of the exhaust ports of the cylinder head, and a collector volume in communication with each of the exhaust runner portions and with an exhaust pipe that conveys the exhaust gases to the ambient environment. Conventionally, the exhaust manifold is formed from stainless steel or cast iron and it is attached to the cylinder head at the opposite side of the intake manifold. However, in order to reduce the overall dimensions of the internal combustion engine, cylinder heads have been recently designed where the exhaust manifold, i.e., the exhaust runner portions and the collector volume, is internally defined by the cylinder head itself to form an integral exhaust manifold.

Many internal combustion engines are further equipped with a turbocharger having the function of increasing the pressure of the air entering the engine cylinders, in order to enhance the engine torque. The turbocharger conventionally comprises a bearing housing, which accommodates a rotating shaft, also referred as turbocharger shaft, and the bearings thereof. The bearing housing is generally formed as an aluminum or iron casting. The opposite ends of the turbocharger shaft jut out from the bearing housing. A turbine wheel is fixed to one end of the turbocharger shaft, whereas the opposite end carries a compressor wheel. The turbine wheel and the compressor wheel are respectively accommodated inside a turbine housing and inside a compressor housing. The turbine housing and the compressor housing are typically formed from stainless steel or cast aluminum and they are fastened at the opposite side of the bearing housing. The turbine housing comprises an inlet in communication with the exhaust manifold and an outlet in communication with the exhaust pipe, so that the turbine wheel rotates by receiving the exhaust gases from the internal combustion engine. The compressor housing comprises an inlet in communication with the intake pipe and an outlet in communication with the intake manifold, so that the rotation of the compressor wheel, driven by the turbine wheel via the turbocharger shaft, increases the pressure of the air in the intake manifold and then in the engine cylinders.

Generally, the entire turbocharger is carried by the turbine housing, whose inlet is defined by a rigid pipe cast in single body with the turbine housing. The free end of this rigid pipe is provided with a connecting flange that is attached to the exhaust manifold, either separated or integrated in the cylinder head, with conventional fastening techniques, such as threaded fasteners. As a matter of fact, the turbine housing is held by the exhaust manifold, whereas the bearing housing is held by the turbine housing itself and the compressor housing is held by the bearing housing, in a cantilever fashion.

Due to the relatively high number of components and fluid connections involved, the mounting of the turbocharger to the internal combustion engine is a rather complicated and time consuming operation. In addition, the mounting of the turbocharger usually takes a relatively great amount of space in the engine compartment of the vehicle, thereby increasing the overall dimensions of the internal combustion engine system.

In view of the foregoing, it is at least one to reduce the number of components and of fluid connections associated with the mounting of the turbocharger, thereby simplifying and speeding up the mounting itself, reducing the amount of space globally occupied by the turbocharger, and also preventing most of the problems that are associated with the fluid connections, such as for example leaking problem. At least another object is that of attaining these goals with a simple, rational and rather inexpensive solution. In addition, other objects, desirable features and characteristics will become apparent from the subsequent summary and detailed description, and the appended claims, taken in conjunction with the accompanying drawings and this background.

### SUMMARY

In particular, an embodiment provides a cylinder head for an internal combustion engine, defining a plurality of exhaust ports and an exhaust outlet; an exhaust manifold internally defined by the cylinder head. The exhaust manifold includes a collector volume in communication with the exhaust ports, through a plurality of exhaust runners, and with the exhaust outlet; a turbocharger housing being defined by the cylinder head and including a turbine volume internally defined by the cylinder head in fluid communication with the exhaust outlet of the exhaust manifold.

This cylinder head provides an integral turbocharger housing, which effectively reduce the number of components to be assembled and to be fluidly connected with each other for mounting the turbocharger. In addition, this cylinder head reduces the overall dimension of the internal combustion engine system.

According to an embodiment, the turbocharger housing further includes a bearing chamber, which is internally defined by the cylinder head, and which is in communication with the turbine volume and with a compressor side opening. This reduces the number of components involved in the assembly of the turbocharger, thereby improving the benefits related therewith.

According to another embodiment, the cylinder head internally defines at least a feeding pipe for feeding a lubricating fluid into the bearing chamber of the turbocharger housing. It is known that a turbocharger generally requires a lubricating fluid (oil) supply to lubricate the bearings associated with the turbocharger shaft. The lubricating fluid is conventionally supplied with external pipes, which fluidly connect the bearing chamber of the turbocharger housing with a lubricating circuit internally defined by the engine block and the cylinder head. The last mentioned embodiment has therefore the advantage of integrating this connecting pipes in the cylinder head, thereby further reducing the number of fluid connections involved in the mounting the turbocharger and the overall dimensions of the internal combustion engine system.

Another embodiment provides that the cylinder head internally defines at least a draining pipe for draining the lubricating fluid from the bearing chamber of the turbocharger housing. This embodiment advantageously allows the lubricating fluid, which has been supplied into the bearing chamber, to be drained therefrom and returned to the engine lubricating circuit. At least another advantage is that of a more complete integration of the turbocharger lubricating system in the cylinder head, thereby enhancing the benefits mentioned above.

According to still another embodiment, the cylinder head internally defines at least a cooling passage in heat exchange relation with the bearing chamber of the turbocharger housing. It is known that some turbochargers, especially larger turbochargers and those installed in heavy duty engines, may require to be cooled down with the aid of a coolant circulation. This coolant circulation is conventionally achieved by providing the turbocharger with an internal cooling circuit, which is fluidly connected with the cooling circuit of the internal combustion engine by means of external pipes. The last mentioned embodiment has therefore the advantage of integrating the turbocharger cooling circuit in the cylinder head, thereby further reducing the number of fluid connections involved in the mounting of the turbocharger and the overall dimensions of the internal combustion engine system.

Another embodiment provides an internal combustion engine comprising the cylinder head described above and a rotating assembly installed into the turbocharger housing. The rotating assembly comprises a turbine wheel, a compressor wheel, a connecting shaft connecting the turbine wheel to the compressor wheel, and bearings coaxially coupled to the connecting shaft. The turbine wheel is accommodated in the turbine volume. The connecting shaft and the bearings are accommodated in the bearing chamber. This embodiment has the same advantages described above, in particular those of reducing the number of components to be assembled and to be fluidly connected with each other for mounting the turbocharger and of reducing the overall dimension of the internal combustion engine.

According to another embodiment, the rotating assembly is installed as a single unit. This embodiment has the advantage of simplifying the assemblage of the turbocharger.

According to another embodiment, the bearing chamber internally defined in the cylinder head is shaped and dimensioned so that the above mentioned rotating assembly can be inserted and removed through the compressor side opening. This embodiment has the advantage of simplifying the installation of the rotating assembly and thus the installation of the entire turbocharger. In this regard, an embodiment provides that the bearing chamber is cylindrical and coaxial with the compressor side opening, and that the turbine wheel of the rotating assembly has an overall diameter that is smaller than the bearing chamber overall diameter and the compressor side opening overall diameter.

According to another embodiment, the bearings of the rotating assembly comprise a turbine bearing and a compressor bearing. The turbine bearing is coupled to the connecting shaft nearer to the turbine wheel than the compressor bearing. This embodiment improves the stability of the rotating assembly.

In order to simplifying the installation of this particular rotating assembly, an embodiment provides that the turbine bearing overall diameter is smaller or equal than/to the compressor bearing overall diameter. Another embodiment provides that the turbine bearing overall diameter is greater than the turbine wheel overall diameter. Still another embodiment provides that the compressor wheel overall diameter is smaller than the compressor bearing overall diameter.

According to another embodiment, the internal combustion engine further comprises a compressor housing accommodating the compressor wheel. This embodiment has the advantage of allowing the complete assemblage of the turbocharger. In order to simplifying this assemblage, the compressor housing may be coupled to the rotating assembly so that they can be installed on the cylinder head as a single component.

### BRIEF DESCRIPTION OF THE DRAWINGS

The detailed description will hereinafter be described in conjunction with the following drawing figures, wherein like numerals denote like elements, and:

FIG. 1 shows an internal combustion engine system according to an embodiment;

FIG. 2 is the section II-II of the internal combustion engine of FIG. 1; and

FIG. 3 is a schematic lateral view of the internal combustion engine of FIG. 1, where an engine lubricant circuit and an engine coolant circuit have been highlighted.

### DETAILED DESCRIPTION

The following detailed description is merely exemplary in nature and is not intended to limit application and uses. Furthermore, there is no intention to be bound by any theory presented in the preceding background or summary or the following detailed description.

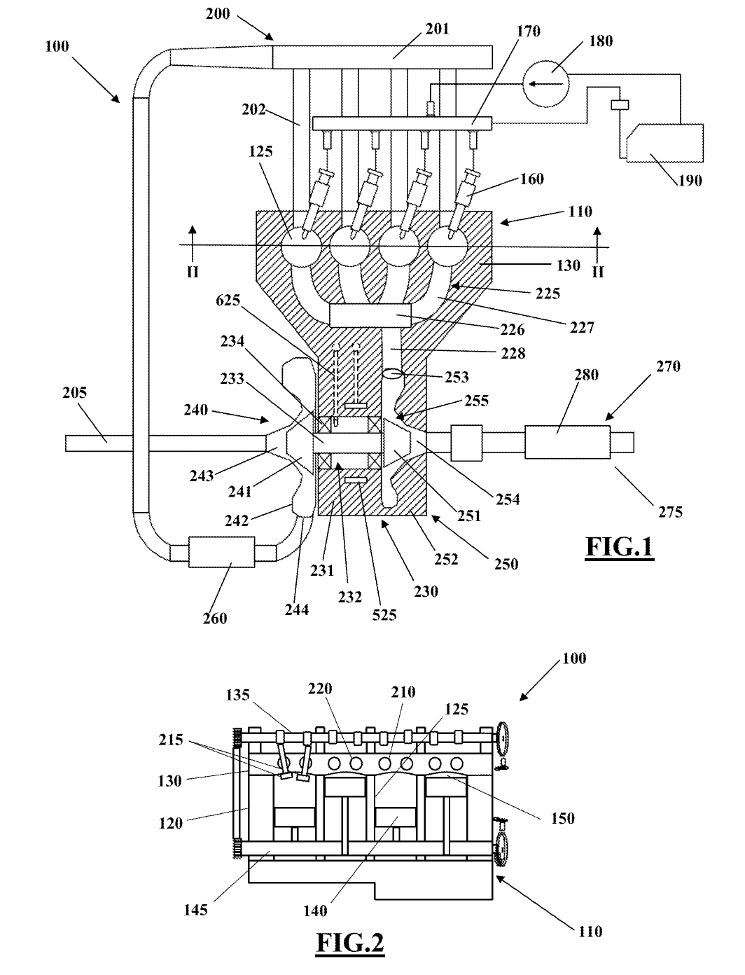

Some embodiments may include an internal combustion engine system 100, as shown in FIG. 1 and FIG. 2, which includes an internal combustion engine (ICE) 110, in this example a Diesel engine. The ICE 110 comprises an engine block 120 and a cylinder head 130 attached to the top of the engine block 120. The engine block 120 and the cylinder head 130 may be formed as aluminum or iron castings, which are removably mounted to each other using conventional fastening techniques, such as threaded fasteners. The engine block 120 defines at least one cylinder 125 having a piston 140 reciprocally movable therein. The cylinder head 130 closes each of the cylinders 125, thereby cooperating with the relative piston 140 to define a variable volume combustion chamber 150. The cylinder head 130 may also define an upper portion of each cylinder 125. In this example, the engine block 120 and the cylinder head 130 are configured to define an in-line four-cylinder ICE 110. However, some embodiments may include an engine block 120 and a cylinder head 130 configured to define a different number of cylinders 125, such as for example 3, 6, 8, 10 or 12. The engine block 120 and the cylinder head 130 may be also configured to define a different engine configuration, such as for example a V-type engine.

A fuel and air mixture (not shown) is disposed in each of the combustion chambers 150 and ignited, resulting in hot expanding exhaust gasses causing reciprocal movement of the pistons 140. The pistons 140 are coupled to a crankshaft 145, so that the reciprocating movement of the pistons 140 is converted in a rotation of the crankshaft 145. The fuel is provided by one fuel injector 160 per cylinder 125. Each of the fuel injectors 160 is received in a bore internally defined by the cylinder head 130 and it is located within the respective cylinder 125. The fuel is provided at high pressure to the fuel injectors 160 from a fuel rail 170, which is in fluid communication with a high pressure fuel pump 180 that increases the pressure of the fuel received from a fuel source 190.

Each of the cylinders 125 has at least two valves 215, actuated by a camshaft 135 rotating in time with the crankshaft 145. The valves 215 selectively allow air into the combustion chamber 150 from at least one intake port 210, and alternately allow exhaust gases to exit the combustion chamber 150 through at least one exhaust port 220. The intake ports 210 and the exhaust ports 220 are internally defined by the cylinder head 130.

The air may be distributed to the intake ports 210 through an intake manifold 200. The intake manifold 200 includes a collector volume 201 and a plurality of runner portions 202, each of which is in fluid communication with the collector volume 201 and with a respective intake port 210 of the cylinder head 130. An air intake pipe 205 may provide air from the ambient environment to the intake manifold 200. The intake manifold 200 may be formed from aluminum or plastic and it may be removably attached to the cylinder head 130 using conventional fastening techniques, such as threaded fasteners.

The exhaust gases exiting the exhaust ports 220 may be collected in an exhaust manifold 225. The exhaust manifold 225 includes a collector volume 226 and a plurality of runner portions 227, each of which is in fluid communication with the collector volume 201 and with a respective exhaust port 220. In this example, the exhaust manifold 225, i.e. the collector volume 226 and the runner portions 227 are internally defined by the cylinder head 130, thereby forming an integral exhaust manifold which advantageously reduces the packaging requirements for the ICE 110. An exhaust outlet 228 is internally defined by the cylinder head 130 and is configured to provide a passage through which the exhaust gases may exit from the collector volume 226.

The internal combustion engine system 100 further comprises a turbocharger 230, which schematically comprises a compressor 240 rotationally coupled to a turbine 250. Rotation of the compressor 240 increases the pressure and temperature of the air in the intake pipe 205 and manifold 200. An intercooler 260 disposed in the intake pipe 205 may reduce the temperature of the air. The turbine 250 operates by receiving exhaust gases from the exhaust manifold 225. Afterward, the exhaust gases exit the turbine 250 and are directed into an exhaust system 270. The exhaust system 270 may include an exhaust pipe 275 having one or more exhaust after-treatment devices 280. The after-treatment devices 280 may be any device configured to change the composition of the exhaust gases. Some examples of after-treatment devices 280 include, but are not limited to, catalytic converters (two and three way), oxidation catalysts, lean NOx traps, hydrocarbon absorbers, selective catalytic reduction (SCR) systems, and particulate filters.

Turning now to the turbine 250, this device comprises a turbine wheel 251 and a turbocharger housing 252. More particularly, the turbocharger housing 252 internally defines a turbine volume 255, in which the turbine wheel 251 is accommodated. The turbine volume 255 includes a radial inlet 253, which is in fluid communication with the exhaust outlet 228 of the exhaust manifold 225, and an axial outlet 254, which is in fluid communication with the exhaust pipe 275 upstream of the after-treatment devices 280. In this way, the exhaust gases coming from the ICE 110 expand into the turbine volume 255 and set the turbine wheel 251 in rotation.

In some embodiments the turbocharger housing 252 may be equipped with a series of internal vanes (not shown) that directs the exhaust gases from the radial inlet 253 towards the turbine wheel 251. An actuator may be provided for moving these vanes, to form a variable geometry turbine (VGT) 250. In other embodiments, the turbine 250 may be of fixed geometry and/or include a waste gate.

The turbine wheel 251 is fixed to one end of a connecting shaft 233, hereafter simply referred as turbocharger shaft, which is rotationally coupled with the turbocharger housing 252. The opposite ends of the turbocharger shaft 233 jut out from the turbocharger housing 252 and carry a compressor wheel 241. More particularly, the turbocharger housing 252 defines a substantially cylindrical bearing chamber 232, which is in communication with the turbine volume 255 and with a compressor side opening 235. The bearing chamber 232 coaxially accommodates the turbocharger shaft 233 and the bearings thereof. These bearings are coaxially coupled to the turbocharger shaft 233, interposed between the latter and the inner surface of the bearing chamber 232. In this example, the bearings of the turbocharger shaft 233 comprise a turbine bearing 234b and a compressor bearing 234a. The turbine bearing 234b is coupled to the turbocharger shaft 233 nearer to the turbine wheel 251 than the compressor bearing 234a. As a consequence, the compressor bearing 234a is coupled to the turbocharger shaft 233 nearer to the compressor wheel 241 than the turbine bearing 234b. The compressor side opening 235 is coaxial with the bearing chamber 232 and it is located at the opposite side of the turbine volume 255, thereby allowing the turbocharger shaft 233 to jut out from the bearing chamber 232 and carry the compressor wheel 241.

In this example, the turbocharger housing 252 is defined by the cylinder head 130. In other words, the turbocharger housing 252 is cast in single body with the cylinder head 130, so that the turbine volume 255, the radial inlet 253, the axial outlet 254, the bearing chamber 232 and the compressor side opening 235, are internally defined by the casting of the cylinder head 130, to form an integral turbocharger housing 252. As a matter of fact, the turbocharger housing 252 of this specific example defines both the so called turbine housing and bearing housing of the turbocharger 230, and it is realized as a portion of the casting of the cylinder head 130.

The turbine wheel 251, the compressor wheel 241, the turbocharger shaft 233 and the bearings 234a and 234b, may be advantageously provided as a preassembled rotating assembly, globally indicated with 300, which may be installed as a single unit into the turbocharger housing 252 of the cylinder head 130. In order to allow the installation of this rotating assembly 300, the bearing chamber 232 is shaped and dimensioned so that the rotating assembly 300 can be inserted and removed through the compressor side opening 235. More particularly, both the overall diameter of the bearing chamber 232 and of the compressor side opening 235 may be greater than the overall diameter of the turbine wheel 251. The overall diameter of the turbine bearing 234b may be greater than the overall diameter of the turbine wheel 251. Furthermore, the overall diameter of the turbine bearing 234b may be smaller or equal than/to the overall diameter of the compressor bearing 234a. The compressor wheel 241 is located outside of the turbocharger housing 252, so that its overall diameter is less critical. In the present example, the compressor wheel 241 has an overall diameter greater than the overall diameter of the compressor bearing 234a. However, the overall diameter of the compressor wheel 241 may be also smaller than the overall diameter of the compressor bearing 234a.

The compressor wheel 241 is accommodated within a compressor housing 242, thereby forming the turbocharger compressor 240. The compressor housing 242 may be formed from stainless steel or cast aluminum and may be fastened to turbocharger housing 252 using conventional fastening techniques, such as threaded fasteners. The compressor housing 242 comprises an axial inlet 243 in fluid communication with the intake pipe 205 and a radial outlet 244 in fluid communication with the intake manifold 200 upstream of the intercooler 260. In this way, the air coming from the intake pipe 205 is compressed within the compressor housing 242 by the rotation of the compressor wheel 241, and distributed under pressure to the intake manifold 200. The rotation of the compressor wheel 241 is caused by the rotation of the turbine wheel 251 via the turbocharger shaft 233.

The compressor housing 242 may be provided as a separated component or as a part on the air induction system. Alternatively, the compressor housing 242 may be coupled to the rotating assembly 300 so that they can be installed and removed on/from the cylinder head 130 as a single preassembled component.

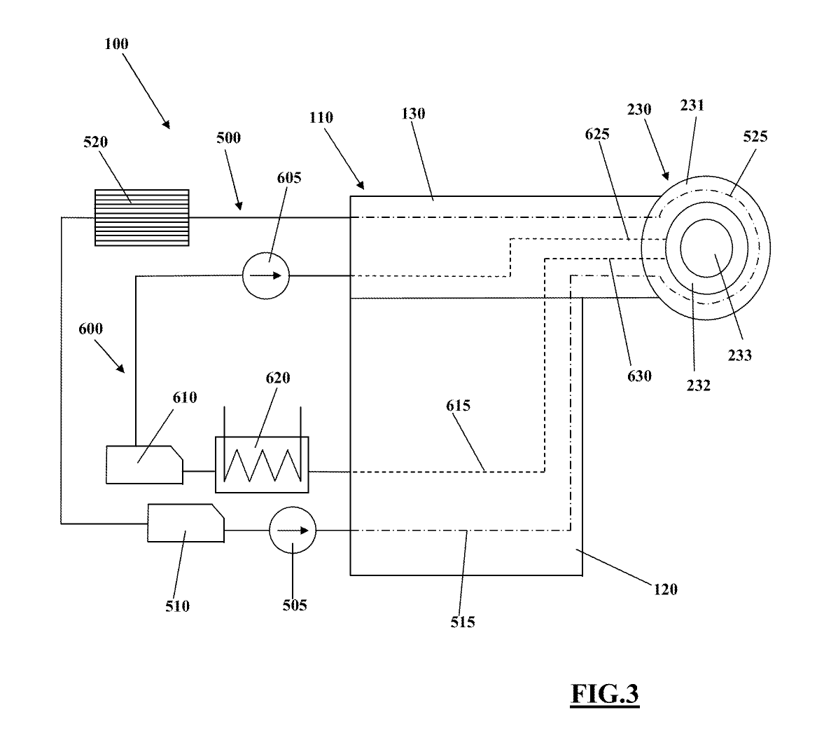

As shown in FIG. 3, the internal combustion engine system 100 may include an engine lubricating circuit 600 for lubricating the rotating and sliding components of the ICE 110. The engine lubricating circuit 600 comprises an oil pump 605 that draws lubricating oil from an oil sump 610 and delivers it under pressure through a plurality of lubricating channels 615 internally defined by the engine block 120 and by the cylinder head 130, and an oil cooler 620 for cooling down the oil, once it has passed through the lubricating channels 615 and before it returns to the oil sump 610. In the accompanying figures, the lubricating channels 615 are simply schematized as a single channel, but those skilled in the art will recognize that the lubricating channels 615 are actually configured to define a much more complicate circuit within the engine block 120 and the cylinder head 130. In particular, the lubricating channels 615 usually include a main oil gallery internally defined by the engine block 120, whence the lubricating oil is directed towards a plurality of exit holes for lubricating many movable components of the ICE 110, before returning in the oil sump 610. These ICE movable components include, but are not limited to, crankshaft bearings (main bearings and big-end bearings), camshaft bearings operating the valves, tappets and the like.

In this example, the lubricating channels 615 include at least a feeding pipe 625, which is internally defined by the cylinder head 130 and which is configured to convey the engine lubricating oil into the bearing chamber 232 of the turbocharger housing 252 (as schematically shown in FIGS. 1 and 3), mainly in order to lubricate the turbocharger shaft 233 and the bearings 234a and 234b thereof. The lubricating channels 615 further include at least a draining pipe 630, which is also internally defined by the cylinder head 130 but which is configured to convey the engine lubricating oil from the bearing chamber 232 of the turbocharger housing 252 towards the oil sump 610.

The internal combustion engine system 100 may further include an engine cooling circuit 500 for cooling the ICE 110. The engine cooling circuit 500 schematically comprises a coolant pump 505 that delivers a coolant, typically a mixture of water and antifreeze, from a coolant tank 510 to a plurality of cooling channels 515 internally defined by the engine block 120 and by the cylinder head 130, and a radiator 520 for cooling down the coolant, once it has passed through the cooling channels 515 and before it returns to the coolant tank 510. Also in this case, those skilled in the art will recognize that the cooling channels 515, simply schematized as a single channel in the accompanying figures, are actually configured to define a much more complicate circuit within the engine block 120 and the cylinder head 130.

In this example, the cooling channels 515 include a cooling passage 525 which is internally defined by the cylinder head 130 and which is in heat exchange relation with the bearing chamber 232 of the turbocharger housing 252. The cooling passage 525 may be internally defined by, and extend into, the turbocharger housing 252, remaining separated from the bearing chamber 232. The cooling passage 525 may include a single pipe or a system of interconnected pipes. The cooling passage 525 may also include an hollow jacket that surrounds the bearing chamber 232 (as schematically shown in FIG. 1). However, those skilled in the art will recognize that the cooling passage 525 may be configured in many other alternative ways, provided that it allows the engine coolant of the engine cooling circuit 500 to exchange heat with the bearing chamber 232 of the turbocharger housing 252, thereby cooling the latter down.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the forgoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and in their legal equivalents.

What is claimed is:

1. A cylinder head for an internal combustion engine that defines a plurality of exhaust ports and an exhaust outlet, comprising:
an exhaust manifold that internally defined by the cylinder head, the exhaust manifold comprising a collector volume in communication with the plurality of exhaust ports through a plurality of exhaust runners, and with the exhaust outlet;
a turbocharger housing that is defined by the cylinder head and comprising a turbine volume internally defined by the cylinder head in a fluid communication with the exhaust outlet of the exhaust manifold.

2. A cylinder head according to claim 1, wherein the turbocharger housing comprises a bearing chamber that is internally defined by the cylinder head and in communication with the turbine volume and with a compressor side opening.

3. A cylinder head according to claim 2, further comprising a feeding pipe that is configured to feed a lubricating fluid into the bearing chamber of the turbocharger housing.

4. A cylinder head according to claim 3, further comprising a draining pipe that is configured to drain the lubricating fluid from the bearing chamber of the turbocharger housing.

5. A cylinder head according to claim 2, further comprising a cooling passage in heat exchange relation with the bearing chamber of the turbocharger housing.

6. An internal combustion engine, comprising:
a cylinder head, comprising:
an exhaust manifold that internally defined by the cylinder head, the exhaust manifold comprising a collector volume in communication with a plurality of exhaust ports through a plurality of exhaust runners, and with an exhaust outlet;
a turbocharger housing that is defined by the cylinder head and comprising a turbine volume internally defined by the cylinder head in a fluid communication with the exhaust outlet of the exhaust manifold; and
a rotating assembly installed into the turbocharger housing, the rotating assembly comprising:
a turbine wheel;
a compressor wheel;
a connecting shaft connecting the turbine wheel to the compressor wheel; and
bearings coaxially coupled onto the connecting shaft, wherein the turbine wheel is accommodated in the turbine volume, and the connecting shaft and the bearings are accommodated in a bearing chamber.

7. The internal combustion engine according to claim 6, wherein the rotating assembly is installed as a single unit.

8. The internal combustion engine according to claim 6, wherein the bearing chamber is shaped and dimensioned so that the rotating assembly is insertable and removable through a compressor side opening.

9. Then internal combustion engine according to claim 8,
wherein the bearing chamber is cylindrical and coaxial with the compressor side opening, and
wherein the overall diameter of the turbine wheel is smaller than an overall diameter of the bearing chamber and an overall diameter of the compressor side opening.

10. Then internal combustion engine according to claim 6,
wherein the bearings of the rotating assembly comprise a turbine bearing and a compressor bearing, and
wherein the turbine bearing is coupled to the connecting shaft that is nearer to the turbine wheel than the compressor bearing.

11. The internal combustion engine according to claim 10, wherein an overall diameter of the turbine bearing is smaller than an overall diameter of the compressor bearing.

12. The internal combustion engine according to claim 10, wherein an overall diameter of the turbine bearing is equal to an overall diameter of the compressor bearing.

13. The internal combustion engine according to claim 11, the overall diameter of the turbine wheel is greater than an overall diameter of the turbine wheel.

14. The internal combustion engine according to claim 10, wherein the overall diameter of the compressor wheel is smaller than an overall diameter of the compressor bearing.

15. The internal combustion engine according to claim 6, further comprising a compressor housing that is configured to accommodate the compressor wheel.

16. The internal combustion engine according to claim 15, wherein the compressor housing is coupled to the rotating assembly and configured for installation on the cylinder head as a single component.
